(19) United States
(12) Patent Application Publication
(10) Pub. No.: US 2004/0055490 A1
(43) Pub. Date: Mar. 25, 2004

(54) Printing plate precursor and printing method

(75) Inventor: Takeshi Sampei, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/655,103

(22) Filed: Sep. 3, 2003

(30) Foreign Application Priority Data
Sep. 20, 2002 (JP) JP2002-274781

(51) Int. Cl. B41N 1/08; B41C 1/10

(52) U.S. Cl. 101/458; 101/455; 101/467

(57) ABSTRACT

Disclosed is a printing plate precursor comprising an aluminum support having been subjected to surface roughening treatment and then to anodizing treatment, and provided thereon, a component layer comprising an image formation layer containing heat melting particles or heat fusible particles, the support satisfying the following conditions (a) and (b):

(a) a surface of the support contains a double structure with a waviness and small pits in the waviness; and

(b) d₁ is from 0.1 to 3 μm, and a ratio h₁/d₁ is not more than 0.4, wherein d₁ (μm) represents an average aperture diameter of the small pits, and h₁ (μm) represents an average depth of the small pits.

### FIELD OF THE INVENTION

The present invention relates to a printing plate precursor and a printing method, and particularly to a printing plate precursor capable of forming an image by a computer to plate (CTP) system and a printing method forming an image by the CTP system.

### BACKGROUND OF THE INVENTION

The printing plate precursor for CTP, which is inexpensive, can be easily handled, and has a printing ability comparable with that of a PS plate, is required accompanied with the digitization of printing data. Recently, a so-called processless printing plate precursor has been noticed which does not require development by a special developing agent.

As one of the image formation methods employing a processless printing plate precursor, an infrared laser image formation method is preferred, and the methods are generally classified into three methods, an ablation method described later, a heat fusion image formation on press development and a heat melt image transfer method.

As a printing plate precursor employing the ablation method, there is one comprising a substrate and a hydrophilic layer or a lipophilic layer as an outermost layer (see, for example, Japanese Patent O.P.I. Publication Nos. 8-507727, 6-186750, 6-199064, 7-314934, 10-58636 and 10-244773). In the printing plate precursor having a hydrophilic layer as an outermost layer, the hydrophilic layer is imagewise exposed to imagewise ablate the hydrophilic layer, whereby the lipophilic layer is exposed to form image portions. However, there are problem that contamination of the interior of the exposing apparatus by scattered matter caused by the ablation of the surface layer. In order to prevent such a scattered matter caused by the ablation of the surface layer, there is a method in which a water soluble protective layer is further provided on the hydrophilic layer and then the ablated layer is removed together with the protective layer on the printing press.

As a printing plate precursor carrying out the heat fusion image formation on press development, there is one comprising an image formation layer containing thermoplastic polymer particles and a water soluble binder on a the hydrophilic layer or on a grained aluminum plate (see, for example, Japanese Patent No. 2938397). However, such a printing plate, when a grained aluminum plate is used as a hydrophilic substrate, is required to contain a light heat conversion material (generally colored) in the image formation layer, and may contaminate a printing press in development on press. In this case, a printing plate precursor is advantageous which comprises a substrate and provided thereon, a hydrophilic layer containing a light heat conversion material and an image formation layer containing no light heat conversion material.

As the heat melt image transfer method, there is a method in which a heat melt material is imagewise transferred onto a hydrophilic surface of a metal sleeve which can be repeatedly used, not on a grained aluminum surface, through a heat transfer ribbon such as DICO web produced by Mannroland Co., Ltd., and heated to fix the resulting image.

However, a printing plate precursor manufactured according to the prior art described above shows poor storage stability in which its performance varies after a long term storage, and provides a printing plate which is insufficient in printing performance, particularly, ink receptivity and printing durability.

### SUMMARY OF THE INVENTION

An object of the invention is to provide a printing plate precursor providing excellent printing performance, particularly, excellent initial printability and excellent printing durability, and having an excellent storage stability in which its performance does not vary after a long-term storage, and a printing method employing the printing plate precursor.

### BRIEF EXPLANATION OF THE DRAWINGS

FIG. 1 shows a magnified sectional view of aluminum support in the invention.

FIG. 2 shows a further magnified sectional view of a part of the aluminum support of FIG. 1.

### DETAILED DESCRIPTION OF THE INVENTION

The above object has been attained by one of the following constitutions:

1. A printing plate precursor comprising an aluminum support having been subjected to surface roughening treatment and then to anodizing treatment, and provided thereon, a component layer comprising an image formation layer containing heat melting particles or heat fusible particles, the support satisfying the following conditions (a) and (b):

(a) a surface of the support contains a double structure with a waviness and small pits in the waviness; and

(b) d₁ is from 0.1 to 3 μm, and a ratio h₁/d₁ is not more than 0.4, wherein d₁ (μm) represents an average aperture diameter of the small pits, and h₁ (μm) represents an average depth of the small pits.

2. The printing plate precursor of item 1 above, wherein the support after anodizing treatment has been treated with an alkali metal silicate.

3. The printing plate precursor of item 1 above, wherein the component layer contains a light heat conversion material.

4. The printing plate precursor of item 1 above, wherein the component layer is comprised of the image formation layer and a hydrophilic overcoat layer provided on the image formation layer.

5. The printing plate precursor of item 1 above, wherein the ratio h₁/d₁ is from 0.1 to 0.3.

6. The printing plate precursor of item 1 above, wherein the average particle diameter of the heat melting particles or heat fusible particles is 0.01 to 10 μm.

7. The printing plate precursor of item 6 above, wherein the average particle diameter of the heat melting particles or heat fusible particles is 0.1 to 3.0 μm.

8. The printing plate precursor of item 1 above, wherein the content of the heat melting particles or heat fusible particles in the image formation layer is from 1 to 90% by weight.

9. The printing plate precursor of item 1 above, wherein the image formation layer contains a water soluble material in an amount of 1 to 90% by weight.

10. The printing plate precursor of item 9 above, wherein the water soluble material is an oligosaccharide.

11. The printing plate precursor of item 10 above, wherein the oligosaccharide is trehalose.

12. The printing plate precursor of item 1 above, wherein the image formation layer contains a light heat conversion material.

13. A printing method comprising the steps of:

forming an image on an image formation layer of the printing plate precursor of claim 1 employing a thermal head and a thermal laser to obtain image portions and non-image portions; and

removing an image formation layer at the non-image portions on a printing press.

14. A printing method comprising the steps of:

forming an image on an image formation layer of the printing plate precursor of claim 1 employing a thermal head and a thermal laser; and

drying the surface of the resulting printing plate precursor before dampening supply rollers or printing ink supply rollers are brought into contact with the surface of the resulting printing plate precursor on a printing press.

2-1. A printing plate precursor comprising an aluminum support having been subjected to surface roughening treatment and then to anodizing treatment, and provided thereon, an image formation layer containing heat melting particles or heat fusible particles, the support satisfying the following conditions (a) and (b):

(a) a surface of the support contains a double structure with a waviness and small pits in the waviness; and

(b) d₁ is from 0.1 to 3 μm, and a ratio h₁/d₁ is not more than 0.4, wherein d₁ (μm) represents an average aperture diameter of the small pits, and h₁ (μm) represents an average depth of the small pits.

2-2. A printing plate precursor comprising a support and provided thereon, an image formation layer containing heat melting particles or heat fusible particles, wherein the support is one in which the support is one in which the support of item 2-1 above has been further treated with an alkali metal silicate.

2-3. The printing plate precursor of item 2-1 or 2-2 above, wherein the printing plate precursor comprises a light heat conversion material on the support.

2-4. The printing plate precursor of any one of items 2-1 through 2-3 above, wherein a hydrophilic overcoat layer is provided on the image formation layer.

2-5. A printing method comprising the steps of:

forming an image on the image formation layer of the printing plate precursor of any one of items 2-1 through 2-4 above employing a thermal head and a thermal laser; and

removing an image formation layer at non-image portions on a printing press.

2-6. A printing method comprising the steps of:

forming image portions on an image formation layer of the printing plate precursor of any one of items 2-1 through 2-4 above employing a thermal head and a thermal laser; and

drying the surface of the resulting printing plate precursor before dampening supply rollers or printing ink supply rollers are brought into contact with the surface of the resulting printing plate precursor on a printing press.

The present invention will be explained below.

The printing plate precursor of the invention comprises an aluminum support having been subjected to surface roughening treatment and then to anodizing treatment, and provided thereon, a component layer including an image formation layer containing heat melting particles or heat fusible particles, the support satisfying the following conditions (a) and (b);

(a) a surface of the support contains a double structure with a waviness and small pits in the waviness, and (b) d₁ is from 0.1 to 3 μm, and a ratio h₁/d₁ is not more than 0.4, wherein d₁ (μm) represents an average aperture diameter of the small pits, and h₁ (μm) represents an average depth of the small pits.

In the aluminum support above, the aperture diameter of the waviness is greater than that of the small pits.

Heat Melting Particles

The heat melting particles used in the invention are particularly particles having a low melt viscosity, or particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to contaminations which may be caused by scratch is further enhanced.

The heat melting particles are preferably dispersible in water. The average particle size thereof is preferably from 0.01 to 10 μm, and more preferably from 0.1 to 3 μm. When a layer containing the heat melting particles is coated on the porous hydrophilic layer, the particles having an average particle size less than 0.01 μm may enter the pores of the hydrophilic layer or the valleys between the neighboring two peaks on the hydrophilic layer surface, resulting in insufficient on press development and background contaminations. The particles having an average particle size exceeding 10 μm may result in lowering of dissolving power.

The composition of the heat melting particles may be continuously varied from the interior to the surface of the particles. The particles may be covered with a different material. Known microcapsule production method or sol-gel method can be applied for covering the particles. The heat melting particle content of the image formation layer is preferably 1 to 90% by weight, and more preferably 5 to 80% by weight based on the image formation layer weight.

Heat Fusible Particles

The heat fusible particles in the invention include thermoplastic hydrophobic polymer particles. Although there is no specific limitation to the upper limit of the softening point of the thermoplastic hydrophobic polymer particles, the softening point is preferably lower than the decomposition temperature of the polymer particles. The weight average molecular weight (Mw) of the polymer is preferably within the range of from 10,000 to 1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm. When a layer containing the heat fusible particles having an average particle size less than 0.01 μm is coated on the porous hydrophilic layer, the particles may enter the pores of the hydrophilic layer or the valleys between the neighboring two peaks on the hydrophilic layer surface, resulting in insufficient on press development and background contaminations. The heat fusible particles having an average particle size exceeding 10 μm may result in lowering of dissolving power.

Further, the composition of the heat fusible particles may be continuously varied from the interior to the surface of the particles. The particles may be covered with a different material. As a covering method, known methods such as a microcapsule method and a sol-gel method are usable. The heat fusible particle content of the layer is preferably from 1 to 90% by weight, and more preferably from 5 to 80% by weight based on the total weight of the layer.

Water Soluble Material

In the invention, the image formation layer containing heat fusible particles or heat melting particles can further contain a water soluble material. When an image formation layer at unexposed portions is removed on a press with dampening water or ink, the water soluble material contained in the image formation layer improves removability of the layer. The water soluble material content of the layer is preferably from 1 to 90% by weight, and more preferably from 10 to 80% by weight, based on the layer weight.

Regarding the water soluble material, those described later as water soluble materials to be contained in the hydrophilic overcoat layer can be used. The image formation layer in the invention preferably contains saccharides, and more preferably contains oligosaccharides. Since the oligosaccharides are easily dissolved in water, removal on a press of unexposed portions of an oligosaccharide-containing layer can be easily carried out dissolving the saccharide in water. The removal does not require a specific system, and can be carried out conducting the same manner as in the beginning of printing of a conventional PS plate, which does not increase loss of prints at the beginning of printing. Use of the oligosaccharide does not lower hydrophilicity of the hydrophilic layer and can maintain good printing performance of the hydrophilic layer. The oligosaccharide is a water-soluble crystalline substance generally having a sweet taste, which is formed by a dehydration condensation reaction of plural monosaccharide molecules. The oligosaccharide is one kind of o-glycoside having a saccharide as the aglycon. The oligosaccharide is easily hydrolyzed by an acid to form a monosaccharide, and is classified according to the number of monosaccharide molecules of the resulting hydrolysis compounds, for example, into disaccharide, trisaccharide, tetrasaccharide, and pentasscharide. The oligosaccharide referred to in the invention means di- to deca-saccharides.

The oligosaccharide is classified into a reducing oligosaccharide and a non-reducing oligosaccharide according to presence or absence of a reducing group in the molecule. The oligosaccharide is also classified into a homo-oligosaccharide composed of the same kind of monosaccharide and a hetero-oligosaccharide composed of two or more kinds of monosaccharides. The oligosaccharide naturally exists in a free state or a glycoside state. Moreover, various oligosaccharides are formed by glycosyl transition by action of an enzyme.

The oligosaccharide frequently exists in a hydrated state in an ordinary atmosphere. The melting points of the hydrated one and anhydrous one are different from each other as shown in the following Table 1.

TABLE 1

Melting point (° C.)

| Kinds of oligosaccharide | | Hydrates | Anhydrides |
|---|---|---|---|
| Raffinose | Trisaccharide | 80 (Pentahydrate) | 118 |
| Trehalose | Disaccharide | 97 (Dihydrate) | 215 |
| Maltose | Disaccharide | 103 (Monohydrate) | 108 |
| Galactose | Disaccharide | 119 (Monohydrate) | 167 |
| Sucrose | Disaccharide | None | 182 |
| Lactose | Disaccharide | 201 (Monohydrate) | 252 |

In the invention, the layer containing a saccharide is preferably formed coating an aqueous coating solution containing the saccharide on a support. When an oligossccharide in the layer formed from the aqueous coating solution is one capable of forming a hydrate, the melting point of the oligosaccharide is that of its hydrate. Since the oligosaccharides, having a relatively low melting point, also melt within the temperature range at which heat melting particles melt or heat fusible particles fuse, they do not inhibit image formation in that the heat melting particles permeate the porous hydrophilic layer and/or the heat fusible particles are heat fused onto the hydrophilic layer.

Among the oligosaccharides, trehalose with comparatively high purity is available on the market, and has an extremely low hygroscopicity, although it has high water solubility, providing excellent storage stability and excellent development property on a printing press.

When oligosaccharide hydrates are heat melted to remove the hydrate water and solidified, the oligosaccharide is in a form of anhydride for a short period after solidification. Trehalose is characterized in that a melting point of trehalose anhydride is not less than 100° C. higher that that of trehalose hydrate. This characteristics provides a high melting point and reduced heat fusibility at exposed portions of the trehalose-containing layer immediately after heat-fused by infrared ray exposure and re-solidified, preventing image defects at exposure such as banding from occurring. In order to attain the object of the invention, trehalose is preferable among oligosaccharides. The oligosaccharide content of the layer is preferably from 1 to 90% by weight, and more preferably from 10 to 80% by weight, based on the total weight of the layer.

It is preferred that the image formation layer contain a light heat conversion material described later.

The dry thickness of the image formation layer is preferably 0.10 to 0.75 g/m², and more preferably 0.15 to 0.50 g/m².

(Hydrophilic Overcoat Layer)

In the invention, a hydrophilic overcoat layer is preferably provided on the image formation layer. The hydrophilic overcoat layer may be provided directly or through an intermediate layer on the image formation layer. It is preferred that the hydrophilic overcoat layer can be removed on a printing press.

In the invention, it is preferred that the hydrophilic overcoat layer contain a water soluble resin or a water swellable resin in which a water soluble resin is partly cross-linked.

The water soluble resin is selected from water soluble natural resins or synthetic resins, and can form a film, when a solution of the water soluble resin and a cross-linking agent is coated on a support, and dried. Preferred examples of the water soluble resin include natural polymers such as gum arabic, water soluble polysaccharides of soy bean, cellulose derivatives (for example, carboxymethyl cellulose, carboxyethyl cellulose, methyl cellulose, etc.) or their modified products, white dextrin, pullulan, and enzymolyzed etherified dextrin, and synthetic polymers such as polyvinyl alcohol (one in which the rate of hydrolysis of polyvinyl acetate is 65% or more), polyacrylic acid or its alkali metal salt or amine salt, a copolymer of acrylic acid or its alkali metal salt or amine salt, copoly(vinylalcohol-acrylic acid) or its alkali metal salt or amine salt, polyacrylamide or an acrylamide copolymer, polyhydroxyethyl acrylate, polyvinyl pyrrolidone or a vinyl pyrrolidone copolymer, polyvinyl methyl ether, copoly(vinyl methyl ether-maleic anhydride), and poly(2-acrylamide-2-methyl-1-propanesulfonic acid) or its alkali metal salt or amine salt.

In the invention, when at least one of the water soluble resins is partially cross-linked to form an overcoat layer on the image formation layer, cross-linking is carried out through a reactive functional group of the water soluble resin. The cross-linking may be carried out through an ionic bond or a covalent bond.

The cross-linking lowers tackiness of the overcoat layer surface, and makes handling easier. Excessive cross-linking makes the overcoat layer oleophilic and lowers removability of the overcoat layer on a printing press. Therefore, proper partial cross-linking is desired. The degree of the partial cross-linking is preferably such that when a printing plate precursor comprising an overcoat layer is immersed in 25° C. water for 30 seconds to 10 minutes, the overcoat layer does not dissolve in the water, but when a printing plate precursor comprising an overcoat layer is immersed in 25° C. water for more than 10 minutes, the overcoat layer dissolves in the water.

Cross-linking agents used for cross-linking reaction include known polyfunctional compounds having a cross-linking capability, for example, polyepoxy compounds, polyamine compounds, polyisocyanate compounds, silane compounds, titanate compounds, aldehyde compounds, polyvalent metal compounds, and hydrazine compounds. Cross-linking reaction can be accelerated employing known catalysts.

Examples of the polyepoxy compounds include glycerin polyglycidyl ether, polyethylene glycol diglycidyl ether, polypropyylene glycol diglycidyl ether, trimethylolpropane polyglycidyl ether, sorbitol polyglycidyl ether, and polucondensation products of bisphenols or their hydrogenated compounds with epihalohydrins.

Examples of the polyamine compounds include ethylenediamine, diethylenetriamine, triethylenetetramine, tetraethylenepentamine, hexamethylenediamine, propylenediamine, polyethylene imine, and polyamidoamines.

Examples of the polyisocyanate compounds include aromatic isocyanates such as tolylene diisocyanate, diphenylmethane isocyanate, liquid diphenylmethane diisocyanate, polymethylenepolyphenyl isocyanate, xylylene diisocyanate, naphthaline-1,5-diisocyanate, cyclohexanephenylene diisocyanate, and isopropylbenzene-2,4-diisocyanate, aliphatic isocyanates such as hexamethylene diisocyanate, and decamethylene diisocyanate, aalicyclic isocyanates such as cyclohexyl diisocyanate and isophorone diisocyanate, and an adduct of polypropylene glycol with tolylene diisocyanate.

Examples of the silane compounds include methyltrimethoxysilane, methyltriethoxysilane, ethyltriethoxysilane, phenyltriethoxysilane, vinyltriethoxysilane, g-aminopropyltriethoxysilane, N-(b-aminoethyl)-g-aminopropyltriethoxysilane, γ-glycidoxypropyltrimethoxysilane, γ-methacryloxypropyltrimethoxysilane, g-mercaptopropyltrimethoxysilane, β-(3,4-epoxycyclohexyl)ethyltrimethoxysilane, dimethyldimethoxysilane, dimethyldiethoxysilane, diphenyldiethoxysilane, 3-chloropropylmethyldimethoxysilane, vinyltrios(methyethylketoxime)silane, methyltris(methylethylketoxime)silane, and vinyltriacetoxysilane.

Examples of the titanate compounds include tetraethylorthosilicate, bis(dioctylpyrophosphate)ethylene titanate, isopropyltrioctanoyltitanate, isopropyldimethacrylisostearoyltitanate, isopropylisostearoyldiacryltitanate, isopropyl(dioctylphosphate)titanate, isopropyltricumylphenyltitanate, isopropyl(N-aminoethylaminoethyl)titanate, dicumylphenyloxyacatatetitanate, diisostearoylethylenetitanate, isopropyltridecylbenzenesulfonyltitanate, isopropyltris(dioctylphosphate)titanate, tetraisopropylbis(dioctylphosphite)titanate, tetraoctylbis(ditridecylphosphite)titanate, tetra(2,2-diallyloxymethyl-1-butyl)bis(ditridecylphosphitetitanate), isopropylbis(dioctylphosphitetitanate), and bis(dioctylpyrophosphate)oxyacetatetitanate.

Examples of the aldehyde compound include formaldehyde, acetoaldehyde, propylaldehyde, butylaldehyde, glyoxal, glutaraldehyde, and terephthalaldehyde.

Examples of the polyvalent metal salt compound include water soluble salts of metals such as zinc, calcium, magnesium, barium, strontium, cobalt, manganese, and nickel.

These cross-linking agents may be used alone or as an admixture of two or more kinds thereof. Among these cross-linking agents, the especially preferred are water soluble cross-linking agents. However, water insoluble cross-linking agents are dispersed in a dispersion medium to obtain a dispersion thereof which is used for cross-linking.

A preferred combination of a water soluble resin and a cross-linking agent is a combination of a carboxyl group-containing water soluble resin and a polyvalent metal salt compound, a combination of a carboxyl group-containing water soluble resin and a water soluble epoxy resin, and a combination of a hydroxyl group-containing water soluble resin and a dialdehyde compound.

The preferred content of the cross-linking agent is 2 to 10% by weight based on the water soluble resin. This content range provides good water resistance without impairing removability of the overcoat layer.

In the invention, the hydrophilic overcoat layer preferably contains a light heat conversion material described later. A coating solution for the overcoat layer may contain a nonionic surfactant in order to secure uniform coatability of the overcoat layer. Examples of the nonionic surfactant include sorbitan tristearate, sorbitan monopalmitate, sorbitan trioleate, stearic acid monoglyceride, polyoxyethylenenonylphenyl ether, and polyoxyethylenedodecyl ether. The content of the nonionic surfactant is preferably 0.05 to 5% by weight, and more preferably 1 to 3% by weight based on the total solid content of the overcoat layer.

In the invention, the dry thickness of the overcoat layer is preferably 0.1 to 0.4 g/m², and more preferably 0.15 to 0.25 g/m². This content range prevents occurrence of staining or scratches or deposition of fingerprints, and minimizes ablation scum without impairing removability of the overcoat layer. In the invention, another layer other than the image formation layer and the hydrophilic overcoat layer can be provided on the aluminum support. Another layer can be provided on the hydrophilic overcoat layer, between the support and the image formation layer, or on the surface of the support opposite the image formation layer.

Light Heat Conversion Material

It is preferred in the invention that the image formation layer, the hydrophilic overcoat layer, or another layer in the invention contain a light heat conversion material. Another layer containing a light heat conversion material is preferably a layer provided on the image formation layer side.

Examples of the light heat conversion material include the following substances:

(Infrared Absorbing Dye)

Examples of the light-heat conversion material include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

(Pigment)

Examples of pigment include carbon, graphite, a metal and a metal oxide. Furnace black and acetylene black is preferably used as the carbon. The graininess (d₅₀) thereof is preferably not more than 100 nm, and more preferably not more than 50 nm.

(Graphite)

The graphite is one having a particle size of preferably not more than 0.5 μm, more preferably not more than 100 nm, and most preferably not more than 50 nm.

(Metal)

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

(Metal Oxide)

As the metal oxide, materials having black color in the visible regions or materials which are electro-conductive or semi-conductive can be used. Examples of the former include black iron oxide (Fe₃O₄), and black complex metal oxides containing at least two metals. Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. The particle size of these particles is preferably not more than 0.5 μm, more preferably not more than 100 nm, and most preferably not more than 50 nm.

Among these light heat conversion materials, black complex metal oxides containing at least two metals are preferred. Typically, the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light heat conversion efficiency as compared with another metal oxide.

The primary average particle size of these complex metal oxides is preferably from 0.001 to 1.0 μm, and more preferably from 0.01 to 0.5 μm. The primary average particle size of from 0.001 to 1.0 μm improves a light heat conversion efficiency relative to the addition amount of the particles, and the primary average particle size of from 0.05 to 0.5 μm further improves a light heat conversion efficiency relative to the addition amount of the particles. The light heat conversion efficiency relative to the addition amount of the particles depends on a dispersity of the particles, and the well-dispersed particles have a high light heat conversion efficiency. Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles.

The addition amount of the complex metal oxide is preferably 0.1 to 50% by weight, more preferably 1 to 30% by weight, and most preferably 3 to 25% by weight based on the weight of hydrophilic layer or under layer.

(Support)

Supports used in the light sensitive planographic printing plate precursor of the invention (hereinafter referred to also as the printing plate precursor of the invention) include a paper sheet, a plastic film (polyethylene, polypropylene, or polystyrene film, etc.) laminated paper sheet, a plate of a metal such as aluminum, (including aluminum alloy), zinc or copper, a film of a plastic such as cellulose diacetate, cellulose triacetate, cellulose propionate, polyethylene terephthalate, polyethylene, polypropylene, polycarbonate or polyvinyl acetal, a paper sheet or plastic film deposited or laminated with the above-described metal, and an iron plate plated with aluminum or chromium. Among the above, the aluminum plate is preferably used, and may be a pure aluminum plate or an aluminum alloy plate. As the aluminum alloy, there can be used various ones including an alloy of aluminum and a metal such as silicon, copper, manganese, magnesium, chromium, zinc, lead, bismuth, nickel, titanium, sodium or iron.

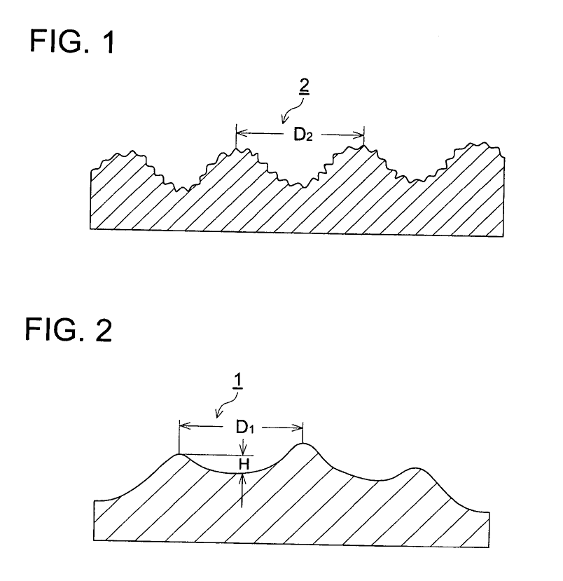

In the invention, the aluminum support has a surface of a double structure with a waviness and small pits in the waviness. FIGS. 1 and 2 show magnified sectional views of the surface of the aluminum support in the invention. FIG. 2 further magnifies FIG. 1. In the FIGS. 1 and 2, numerical number 1 represents a small pit, numerical number 2 a waviness and small pits in the waviness, D₁ (μm) an aperture diameter of the small pit 1, H (μm) a depth of the small pit 1, and D₂ (μm) an aperture diameter (peak to peak distance) of the waviness 2. It is essential in the invention that the average aperture diameter d₁ (μm) of small pits be from 0.1 to 3 μm, and a ratio of the average depth h (μm) of the small pits to the average aperture diameter d₁ (μm) of the small pits be not more than 0.4. The ratio h/d₁ is preferably from 0.1 to 0.3.

The average aperture diameter d₂ (μm) of the waviness on the aluminum support is preferably from more than 3 μm to 20 μm, and this range of the average aperture diameter of the waviness can prevent deposition of fingerprints on the printing plate precursor.

(Surface Treatment of Support)

The aluminum support is subjected to dissolution treatment employing an alkali solution, for example, an aqueous sodium hydroxide solution in order to remove stains or naturally produced oxidation film on the surface. The resulting aluminum support is subjected to neutralization treatment in which the support is immersed in an aqueous solution of an acid such as phosphoric acid, nitric acid, sulfuric acid, hydrochloric acid, chromic acid or a mixture thereof, in order to neutralize the residual alkali on the support surface. The surface of the aluminum support may be subjected to solvent degreasing treatment employing solvents such as trichlene and thinner or to emulsion degreasing treatment employing an emulsion such as kerosene or triethanol for removing oil, rust or dust on the surface.

After the dissolution treatment employing an alkali solution or the neutralization treatment by acids, electrolytic surface roughening treatment described later is carried out, and it is preferred that composition or kinds of the acid in the solution used in the neutralization treatment is the same as that of the electrolytic solution used in the electrolytic surface roughening treatment.

Prior to the above dissolution treatment employing the alkali solution, the support may be treated according to a mechanical surface roughening method. Though there is no restriction for the mechanical surface roughening method, a brushing roughening method and a honing roughening method are preferable. The brushing roughening method is carried out by rubbing the surface of the support with a rotating brush with a brush hair with a diameter of 0.2 to 1 mm, while supplying slurry in which abrasives are dispersed in water to the surface of the support. The honing roughening method is carried out by ejecting obliquely slurry with pressure applied from nozzles to the surface of the support, the slurry containing abrasives dispersed in water. A surface roughening can be also carried out by laminating a support surface with a sheet surface-roughened in advance on the surface and applying pressure to the sheet to transfer the roughened pattern of the sheet, whereby a surface-roughened support is obtained.

When the above mechanical surface roughening method is carried out, the above solvent degreasing treatment or emulsion degreasing treatment can be eliminated.

After the dissolution treatment employing an alkali solution or neutralization treatment by acids (or optional degreasing treatment), the aluminum support is subjected to electrolytic surface roughening treatment in an acidic electrolytic solution employing an alternating current. It is preferred in the invention that a suspension time from 0.6 to 5 seconds, during which no electrolytic surface roughening treatment is carried out, be intervened during separate electrolytic surface roughening treatments, and one electrolytic surface roughening treatment after each suspension time employs a quantity of electricity of not more than 100 C/dm². When the separate electrolytic surface roughening treatments are carried out dividing into plural treatments, such a quantity of electricity and suspension time as described above are preferred in view of obtaining the aluminum support as defined in the invention, and providing improved productivity of the aluminum support.

Though an electrolytic solution of hydrochloric acid or nitric acid is used as an electrolytic solution for the electrolytic surface roughening treatment, it is preferable to use a hydrochloric acid electrolytic solution. It is possible to optionally add, to the electrolytic solution, nitrates, chlorides, amines, aldehydes, phosphoric acid, chromic acid, boric acid, acetic acid or oxalic acid. Acetic acid is preferably added. In the electrolytic surface roughening method, voltage applied is generally from 1 to 50 V, and preferably from 5 to 30 V. The current density (in term of peak value) used is preferably from 10 to 200 A/dm², and is more preferably from 20 to 150 A/dm². The quantity of electricity is preferably from 100 to 2000 C/dm², and is preferably 200 to 1000 C/dm² in the total electrolytic surface roughening process. The temperature during the electrolytically surface roughening is preferably from 10 to 50° C., and more preferably from 15 to 45° C.

The hydrochloric acid concentration of the electrolytic solution is preferably 0.1 to 5% by weight. The electric current wave shape used in the electrolytic surface roughening treatment is suitably selected from a sine wave, a rectangle wave, a trapezoid wave or a saw-tooth wave due to an intended roughening pattern. The sine wave is preferred.

After the support has been electrolytically surface roughened, the support is subjected to etching treatment in which it is dipped in an acid or an aqueous alkali solution in order to remove aluminum smut produced on the surface of the support or to control the pit shape. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The support is preferably treated in an aqueous solution containing 0.05 to 40% by weight of the aforementioned alkali. After that, the support is dipped in an acid such as phosphoric acid, nitric acid, sulfuric acid and chromic acid, or in a mixed acid thereof, for neutralization.

After the neutralization, anodizing treatment may be carried out to obtain the aluminum support in the invention. Herein, kinds of acids used in the anodizing treatment are preferably the same as the kinds of acids used in the neutralization.

The electrolytic solution used in the anodizing treatment may be any, as long as it can form a porous anodizing film on the support surface. Generally, sulfuric acid, phosphoric acid, oxalic acid, chromic acid, sulfamic acid, benzene sulfonic acid or a mixture of two or more kinds thereof is used. The electrolytic solution used in the anodizing treatment has an electrolyte concentration of preferably from 1 to 80% by weight. In the anodizing treatment, temperature used is preferably from 5 to 70° C., the current density supplied is preferably from 1 to 60 A/cm², the voltage applied is preferably from 1 to 100 V, and anodization time is preferably from 10 seconds to 5 minutes. The anodizing treatment is preferably carried out in a sulfuric acid solution, ordinarily employing direct electric current. An alternating electric current can be used. Herein, the sulfuric acid concentration is preferably from 10 to 50% by weight, temperature used is preferably from 20 to 50° C., the current density supplied is preferably from 1 to 20 A/cm², and anodization time is preferably from 10 seconds to 5 minutes. The electrolytic solution preferably contains an aluminum ion.

By appropriately controlling conditions of the surface roughening treatments and the anodizing treatment described above, an aluminum support satisfying the conditions (a) and (b) described above can be obtained.

The aluminum support which has been subjected to anodizing treatment is optionally subjected to sealing treatment. For the sealing treatment, it is possible to use known methods using hot water, boiling water, steam, a sodium silicate solution, an aqueous dicromate solution, a nitrite solution and an ammonium acetate solution.

After the anodizing treatment or the sealing treatment, a hydrophilic layer may be provided on the resulting aluminum support. As the hydrophilic layer can be used an alkali metal silicate layer disclosed in U.S. Pat. No. 3,181,461, a hydrophilic cellulose layer disclosed in U.S. Pat. No. 1,860,426, a layer of an amino acid or its salt disclosed in Japanese Patent Nos. 6-94234 and 6-2436, a layer of an amino acid with a hydroxyl group or its salt disclosed in Japanese Patent No. 5-32238, a phosphate layer disclosed in Japanese Patent O.P.I. Publication No. 62-19494, and a layer of a polymer with a sulfo group disclosed in Japanese Patent O.P.I. Publication No. 59-101651.

In order to prevent scratches produced on a rear surface of the support opposite the light sensitive layer in stacked plural printing plate precursors or to prevent the aluminum of the support from dissolving out into a developer during development, a protective layer can be provided on the rear surface of the support, as disclosed in Japanese Patent O.P.I. Publication Nos. 50-151136, 57-63293, 60-73538, 61-67863, and 6-35174.

The present invention provides a printing method comprising the steps of forming an image on the image formation layer of the printing plate precursor of the invention employing a thermal head and a thermal laser, and removing an image formation layer at non-image portions on a printing press.

Image formation in the printing plate precursor of the invention is carried out by applying heat and can be carried out employing a thermal head used in a thermal printer, but is carried out preferably by thermal laser exposure.

Exposure applied in the invention is preferably scanning exposure, which is carried out employing a laser which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate precursor according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate precursor mounted on a plate cylinder of a printing press is scanning exposed.

Employing the thus printing plate precursor with an image, printing is carried out without development process. After the printing plate precursor with an image is mounted on a plate cylinder of a printing press, or after the printing plate precursor is mounted on the cylinder and then imagewise heated to obtain a printing plate precursor with an image, a dampening water supply roller and/or an ink supply roller are is brought into contact with the surface of the resulting printing plate precursor while rotating the plate cylinder to remove non-image portions of the printing plate precursor (so-called, development on press).

The non-image portion removal process as described above in the printing plate precursor of the invention can be carried out in the process sequences processing conventional. This means that processing time is shortened due to development on press, resulting in lowering of cost.

### EXAMPLES

### Example 1

<Preparation of Support>

A 0.24 mm thick aluminum plate (JIS1050) was immersed in an aqueous 1% sodium hydroxide solution, wherein the aluminum dissolution amount was 2 g/m², and washed with water. The resulting aluminum plate was immersed for 10 seconds in an aqueous solution having the same composition as that of an electrolytic solution used in the following electrolytic roughening treatment, neutralized, and then washed with water.

The resulting aluminum plate was subjected to electrolytic surface roughening treatment using alternating current with a sine waveform at 25° C. at a current density of 50 A/dm² under the conditions as shown in Table 1 (electrolytic solution composition, quantity of electricity used per single electrolytic surface roughening treatment, the number of electrolytic surface roughening treatments, suspension time). The resulting plate was immersed in an aqueous 5% sodium hydroxide solution at 50° C. to give an aluminum dissolution amount of 2 g/m², washed with water, neutralized in an aqueous 10% sulfuric acid solution at 25° C. for 10 seconds, and washed with water.

Subsequently, the aluminum plate was anodized at 25° C. employing direct current at a current density of 5 A/dm² to give an anodization film with a thickness of 2.0 g/m², washed with water and dried. Thus, support samples 1 through 8 were obtained. In the resulting support samples, the average aperture diameter d₂ (μm) of the waviness, the average aperture diameter d₁ (μm) of the small pits, and the ratio h/d₁ of the average depth h (μm) of the small pits to the average aperture diameter d₁ (μm) of the small pits were determined according to the method described later. The results are shown in Table 2.

Samples 1 through 8 were immersed in an aqueous 2.5% sodium silicate solution at 70° C. for 1 minute, washed with water, and dried. Thus, inventive aluminum support samples were obtained. Sample 8 was not immersed in the aqueous 2.5% sodium silicate solution.

<Determination of Average Aperture Diameter d₂ (μm) of Waviness and Average Aperture Diameter d₁ (μm) of Small Pits, and the Ratio h/d₁ of Average Depth h (μm) of Small Pits to Average Aperture Diameter d₁ (μm) of the Small Pits>

These were determined employing SEM photographs of the aluminum support surface.

The average aperture diameter d₂ (μm) of waviness was determined employing a 1000 power SEM photograph of the waviness. In the photograph, the longest diameter and the shortest diameter of the aperture of waviness having a clear contour were measured and the average thereof was regarded as the aperture diameter of the waviness. The average aperture diameter d₂ (μm) of the waviness was obtained by dividing the sum of the waviness aperture diameter measured by the number of waviness to have been measured. The number was ten. The average aperture diameter d₁ (μm) of the small pits existing in the waviness to have been measured was obtained in the same manner as in the waviness above, except that a 5000 power SEM photograph of the small pits was employed.

Ratio h/d₁ of average depth h (μm) of small pits to of the small pits was determined employing a 5000 to 20000 power SEM photograph of a section of the aluminum support. Measurement were carried out regarding a small pit of a support section obtained by cutting the support with a line including the center of the small pit. The results are shown in Table 2.

TABLE 2

| | Electrolytic solution | | | | | | | | |
|---|---|---|---|---|---|---|---|---|---|
| | composition (q/l) | | | | | | | | |
| Sup- | Hydro- | Ace- | | | | | | | |
| port | chloric | tic | Nitric | | | | | | |
| No. | acid | acid | acid | *1 | *2 | *3 | *4 | *5 | *6 |
| 1 | 10 | 0 | 0 | 80 | 6 | 1.0 | 10.5 | 1.2 | 0.15 |
| 2 | 10 | 10 | 0 | 60 | 8 | 3.0 | 5.3 | 0.8 | 0.20 |
| 3 | 10 | 0 | 0 | 40 | 12 | 4.0 | 4.8 | 0.6 | 0.18 |
| 4 | 10 | 20 | 0 | 100 | 2 | 0.8 | 5.0 | 0.8 | 0.20 |
| 5 | 10 | 0 | 0 | 80 | 6 | 1.0 | 6.2 | 0.8 | 0.30 |
| 6 | 10 | 10 | 0 | 125 | 4 | 2.0 | 11.6 | 0.6 | 0.30 |
| 7 | 0 | 0 | 10 | 100 | 6 | 1.0 | 8.5 | 0.8 | 0.30 |
| 8 | 0 | 0 | 16 | 500 | 1 | None | Wavi- | 1.8 | 0.45 |
| | | | | | | | ness | | |
| | | | | | | | was | | |
| | | | | | | | not | | |
| | | | | | | | pro | | |
| | | | | | | | duced | | |

*1: Quantity of electricity used per one electrolytic surface roughening treatment (C/dm²)
*2: Number of electrolytic surface roughening treatments
*3: Suspension time (second)
*4: Average aperture diameter of waviness (pm)
*5: Average aperture diameter of small pits (pm)
*6: Ratio of average depth of small pits to the average aperture diameter of the small pits

Coating of Image Formation Layer

The composition as shown in Table 3 was sufficiently mixed, and filtered to obtain a coating solution for an image formation layer. In Table 3, “parts” is “parts by weight”, unless otherwise specified.

TABLE 3

| | Image | Image |
|---|---|---|
| | formation | formation |
| | layer | layer |
| | coating | coating |
| | solution 1 | solution 2 |
| Materials | (parts) | (parts) |
| Aqueous 10% by weight solution of | 20 | 20 |
| disaccharide trehalose powder (Treha, | | |
| mp. 97° C., produced by Hayashibara | | |
| Shoji Co., Ltd.) | | |
| Dispersion prepared by diluting with | — | 60 |
| pure water carnauba wax emulsion A118 | | |
| (having a solid content of 40% by | | |
| weight, the wax having an average | | |
| particle size of 0.3 μm, a melting | | |
| point of 65° C., and a melting | | |
| viscosity at 140° C. of 8 cps, | | |
| produced by GifuCerac Co., Ltd.) to | | |
| give a solid content of 10% by weight | | |
| Infrared absorbing dye A | 0.2 | 0.2 |
| Pure water | 79.8 | 19.8 |

Infrared Absorbing Dye A

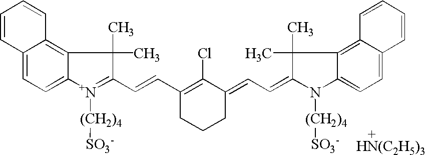

The above-obtained coating solution was coated on the support obtained above employing a wire bar to obtain a combination as shown in Table 4, and dried to give an image formation layer having a dry thickness of 1.5 g/m². The drying was carried out at 55° C. for 3 minutes, and further aged at 55° C. for 24 hours.

[Coating of Hydrophilic Overcoat Layer]

An overcoat layer coating solution having the following composition was coated on the image formation layer employing a wire bar, dried at 100° C., to obtain a printing plate precursor having an overcoat layer with a dry thickness of 0.3 g/m². The printing plate precursor was further aged at 55° C. for 24 hours.

(Hydrophilic overcoat layer coating solution)

| | | |
|---|---|---|
| Aqueous solution containing 28% by weight | 7.5 | g |
| of gum arabic | | |
| Infrared absorbing dye A | 0.7 | g |
| Ten % polyoxyethylenenonyl phenyl ether | 0.8 | g |
| Ion-exchange water | 191 | g |
| Image formation | | |

Image formation was carried out by scanning exposure due to infrared laser. Scanning exposure was carried out employing an infrared laser (having a wavelength of 830 nm and a beam spot diameter of 18 μm) at an exposure energy of 300 mJ/cm², at a resolution of 2400 dpi and at a screen line number of 175 to form an image, the beam being focused on the surface of the image formation layer. The term, “dpi” shows the number of dots per 2.54 cm. A solid image and an image with a dot area of from 1 to 99% were employed as an image for evaluation.

Evaluation of Printing Performance

Employing the exposed printing plate sample obtained above, printing described below was carried out and printing performance was evaluated.

(Printing Method)

The exposed printing plate precursor sample was mounted on a printing press, DAIYA 1F-1 produced by Mitsubishi Jukogyo Co., Ltd. Printing was carried out employing a coated paper, dampening water, a 2% by weight solution of Astromark 3 (produced by Nikken Kagaku Kenkyusyo Co., Ltd.), and printing ink (Toyo King Hyecho M Magenta, produced by Toyo Ink Manufacturing Co.). Printing was carried out in the same manner as sequence carried out in the conventional PS plate, except that development employing a special developer was not carried out. After printing, it has been observed that the image formation layer at non-image portions of the inventive printing plate precursor samples was removed.

Evaluation of Initial Printability

The number of paper sheets printed from when printing began to when print with a good S/N ratio was obtained was counted and evaluated as a measure of initial printability. The less the number is, the better. Herein, “print with a good S/N ratio” refers to print in which, the image formation layer at the non-image portions being removed on the printing press, no stain was observed at the no-image portions, and a sufficient image density was observed at the image portions. The number not less than 40 is practically problematic.

Evaluation of Printing Durability

One hundred thousand paper sheets were printed. The number of printed sheets at which a half or more of 3% dots at the image portions lacked was determined. The more the number is, the more excellent the printing durability. The results are shown in Table 4.

TABLE 4

| | | Composition | | | |
|---|---|---|---|---|---|
| | Aluminum | of image | | | |
| Sample | support | formation | Initial | Printing | Re- |
| No. | used | layer | printability | durability | marks |
| 101 | 1 | 2 | 4 | ≧100,000 | Inv. |
| 102 | 2 | 2 | 5 | ≧100,000 | Inv. |
| 103 | 3 | 2 | 5 | ≧100,000 | Inv. |
| 104 | 4 | 2 | 5 | ≧100,000 | Inv. |
| 105 | 5 | 2 | 4 | ≧100,000 | Inv. |
| 106 | 6 | 2 | 5 | ≧100,000 | Inv. |
| 107 | 7 | 2 | 4 | ≧100,000 | Inv. |
| 108 | 8 | 2 | 50 | 10,000 | Comp. |
| 109 | 8 | 1 | 200 | 1,000 | Comp. |

As is apparent from Table 4 above, inventive samples provide excellent initial printability and excellent printing durability.

### Example 2

The printing plate precursor samples 201 through 208 were prepared in the same manner as in Example 1, except that the image formation layer coating solution 3 as shown in Table 5 was used as an image formation layer coating solution and the hydrophilic overcoat layer coating solution composition 4 described below was used. In Table 5, “parts” is “parts by weight”, unless otherwise specified.

TABLE 5

| | Image |
|---|---|
| | formation |
| | layer |
| | coating |
| | solution 3 |
| Materials | (parts) |
| Aqueous 10% by weight solution of disaccharide | 20 |
| trehalose powder (Treha, mp. 97° C., produced | |
| by Hayashibara Shoji Co., Ltd.) | |
| Dispersion prepared by diluting with pure water | 60 |
| carnauba wax emulsion A118 (having a solid | |
| content of 40% by weight, the wax having an | |
| average particle size of 0.3 μm, a melting | |
| point of 65° C., and a melting viscosity | |
| at 140° C. of 8 cps, produced by GifuCerac | |
| Co., Ltd.) to give a solid content of 10% by weight | |
| Cu—Fe—Mn type metal oxide black pigment: TM-3550 | 1 |
| black aqueous dispersion {prepared by dispersing | |
| TM-3550 black powder having a particle size of | |
| 0.1 μm produced by Dainichi Seika Kogyo Co., Ltd. | |
| in water to give a solid content of 40.5% by | |
| weight (including 0.5% by weight of dispersant) } | |
| Infrared absorbing dye A | 0.2 |
| Pure water | 18.8 |

Hydrophilic overcoat layer coating solution composition 4

| | | |
|---|---|---|
| Aqueous solution containing 28% by weight | 7.5 | g |
| of gum arabic | | |
| Infrared absorbing dye A | 0.7 | g |
| Ten % polyoxyethylenenonyl phenyl ether | 0.8 | g |
| Porous metal oxide particles Silton JC 40 | 3 | g |
| (porous aluminosilicate particles having | | |
| an average particle size of 4 μm, | | |
| produced by Mizusawa Kagaku Co., Ltd.) | | |
| Aqueous 4% by weight sodium carboxymethyl | 2 | g |
| cellulose solution (Reagent produced | | |
| by Kanto Kagaku Co., Ltd.) | | |
| Colloidal silica (alkali type) Snowtex S | 2 | g |
| (solid 30% by weight, | | |
| produced by Nissan Kagaku Co., Ltd.) | | |
| Ion-exchange water | 184 | g |
| Evaluation of storage stability | | |

The resulting printing plate precursor samples were stored at 50° C. for 3 days, and then the same evaluation was carried out in the same manner as in Example 1. The results are shown in Table 6.

TABLE 6

| | | Composition | | | |
|---|---|---|---|---|---|
| | Aluminum | of image | | | |
| Sample | support | formation | Initial | Printing | Re- |
| No. | used | layer | printability | durability | marks |
| 201 | 1 | 2 | 5 | ≧100,000 | Inv. |
| 202 | 2 | 2 | 5 | ≧100,000 | Inv. |
| 203 | 3 | 2 | 5 | ≧100,000 | Inv. |
| 204 | 4 | 2 | 5 | ≧100,000 | Inv. |
| 205 | 5 | 2 | 5 | ≧100,000 | Inv. |
| 206 | 6 | 2 | 5 | ≧100,000 | Inv. |
| 207 | 7 | 2 | 5 | ≧100,000 | Inv. |
| 208 | 8 | 2 | 60 | 5,000 | Comp. |
| 209 | 8 | 1 | 300 | 1,000 | Comp. |

As is apparent from Table 6 above, inventive samples provide excellent initial printability and excellent printing durability.

### Example 3

Sample No. 201 in Example 2 was imagewise exposed in the same manner as in Example 1, except that the procedure as shown in Table 7 was added at exposure. After that, the exposed sample was linked with developing ink (Protection ink PI-2, produced by Fuji Photo Co., Ltd) at the timing as shown in Table 7 to form an image. The resulting image was observed by means of a magnifying glass. The results are shown in Table 7.

TABLE 7

| Procedure at | | Evaluation of |
|---|---|---|
| exposure | Timing of inking | ink image |
| None | Fifteen seconds | An image with a dot |
| | after exposed, the | area of from 1 to |
| | sample was inked on | 98% was completely |
| | the exposure drum. | reproduced at the |
| | | scanning exposure |
| | | starting portions, |
| | | but an image with a |
| | | dot area of not less |
| | | than 95% was clogged |
| | | at the scanning |
| | | exposure finishing |
| | | portions. |
| None | After exposure, the | An image with a dot |
| | sample was | area of from 1 to |
| | dismounted from the | 98% was completely |
| | exposure drum, and | reproduced at the |
| | allowed to dry at | scanning exposure |
| | room temperature. | starting portions |
| | Three minutes after | through the scanning |
| | exposed, the sample | exposure finishing |
| | was inked. | portions. |
| | | An image with a dot |
| | | area of from 1 to |
| Scan of the exposure | Fifteen seconds | 98% was completely |
| head was followed by | after exposed, the | reproduced at the |
| drying the exposed | sample was inked on | scanning exposure |
| portions with a dry | the exposure drum. | starting portions |
| air. | | through the scanning |
| | | exposure finishing |
| | | portions. |

As is apparent from Table 7 above, drying after exposure provides an excellent image reproduction.

### EFFECTS OF THE INVENTION

The present invention can provide a printing plate precursor providing excellent printing performance, particularly, excellent initial printability and excellent printing durability, and having an excellent storage stability in which its performance does not vary after a long-term storage, and a printing method employing the printing plate precursor.

What is claimed is:

1. A printing plate precursor comprising an aluminum support having been subjected to surface roughening treatment and then to anodizing treatment, and provided thereon, a component layer comprising an image formation layer containing heat melting particles or heat fusible particles, the support satisfying the following conditions (a) and (b):
(a) a surface of the support contains a double structure with a waviness and small pits in the waviness; and
(b) d₁ is from 0.1 to 3 μm, and a ratio h₁/d₁ is not more than 0.4, wherein d₁ (μm) represents an average aperture diameter of the small pits, and h₁ (μm) represents an average depth of the small pits.

2. The printing plate precursor of claim 1, wherein the support after anodizing treatment has been treated with an alkali metal silicate.

3. The printing plate precursor of claim 1, wherein the component layer contains a light heat conversion material.

4. The printing plate precursor of claim 1, wherein the component layer is comprised of the image formation layer and a hydrophilic overcoat layer provided on the image formation layer.

5. The printing plate precursor of claim 1, wherein the ratio h₁/d₁ is from 0.1 to 0.3.

6. The printing plate precursor of claim 1, wherein the average particle diameter of the heat melting particles or heat fusible particles is 0.01 to 10 μm.

7. The printing plate precursor of claim 6, wherein the average particle diameter of the heat melting particles or heat fusible particles is 0.1 to 3.0 μm.

8. The printing plate precursor of claim 1, wherein the content of the heat melting particles or heat fusible particles in the image formation layer is from 1 to 90% by weight.

9. The printing plate precursor of claim 1, wherein the image formation layer contains a water soluble material in an amount of 1 to 90% by weight.

10. The printing plate precursor of claim 9, wherein the water soluble material is an oligosaccharide.

11. The printing plate precursor of claim 10, wherein the oligosaccharide is trehalose.

12. The printing plate precursor of claim 1, wherein the image formation layer contains a light heat conversion material.

13. A printing method comprising the steps of:
forming an image on an image formation layer of the printing plate precursor of claim 1 employing a thermal head and a thermal laser to obtain image portions and non-image portions; and
removing an image formation layer at the non-image portions on a printing press.

14. A printing method comprising the steps of:
forming an image on an image formation layer of the printing plate precursor of claim 1 employing a thermal head and a thermal laser; and
drying the surface of the resulting printing plate precursor before dampening supply rollers or printing ink supply rollers are brought into contact with the surface of the resulting printing plate precursor on a printing press.
